(19) United States
(12) Patent Application Publication
(10) Pub. No.: US 2007/0193859 A1
(43) Pub. Date: Aug. 23, 2007

(54) Transport apparatus

(75) Inventors: Senzo Kyutoku, Mie (JP); Tatsuo Tsubaki, Mie (JP); Masanao Murata, Mie (JP)

Correspondence Address: DRINKER BIDDLE & REATH (DC), 1500 K STREET, N.W., SUITE 1100, WASHINGTON, DC, 20005-1209, US

(73) Assignee: ASYST SHINKO, INC.

(21) Appl. No.: 11/708,065

(22) Filed: Feb. 20, 2007

(30) Foreign Application Priority Data
Feb. 21, 2006 (JP) P.2006-043573

(51) Int. Cl. B65G 13/02

(52) U.S. Cl. 198/787

(57) ABSTRACT

A branch portion 2c is provided with a branch track 6 for guiding a carrier 8 having been guided in a straight line direction so as to change the traveling direction thereof, and a linear track 5 for guiding the carrier in the straight line direction. A switching unit switches between the branch track 6 and the linear track 5 so as to guide the carrier 8 by one of the branch track 6 and the linear track 5 in accordance with the traveling direction of the carrier 8.

This application claims priority from Japanese Patent application No. 2006-043573, filed Feb. 21, 2006, the contents of which is incorporated herein by reference in its entirety.

### BACKGROUND OF THE INVENTION

1. Field of the Invention

The present invention relates to a transport apparatus for transporting an article to be transported.

2. Description of the Related Art

In a manufacturing factory such as a semiconductor manufacturing factory or a liquid crystal display panel manufacturing factory, it is known that a transport system using a transport conveyer, an Over head Hoist Transport (OHT), an Over Head Shuttle (OHS) and so on transports a carrier which houses therein articles in the manufacturing process in accordance with a process. Further, the articles in the manufacturing may include subjects to be processed such as semiconductor substrates, glass substrates for liquid crystal display apparatuses, glass substrates for photo masks or substrates for optical discs.

As disclosed in Japanese Patent Unexamined Publication: JP-T-2003-506289, in order to change the traveling direction of a carrier by 90 degrees, for example, at one of the four corners or at a T cross of a transport conveyer, the carrier is temporarily stopped on a turntable, then the turntable is turned by 90 degrees together with the carrier and the transportation of the carrier is started again. In order to use the turntable for transporting the next carrier, the turntable thus turned by 90 degrees is tuned by 90 degrees in the reverse direction and restored to an original point after the current carrier on the turntable moves out of the turntable.

However, in the JP-T-2003-506289, when changing the traveling direction of the carrier by 90 degrees, it is required to perform the step of temporarily stopping the carrier on the turntable, the step of turning by 90 degrees the turntable on which the carrier is placed, the step of starting the transportation of the carrier again and the step of restoring the turntable to the original point. Thus, since it takes a long time to change the direction of the single carrier, a jam is caused in such a case of transporting a plurality of carriers continuously.

### SUMMARY OF THE INVENTION

The invention is accomplished in view of the above problems. An object of the present invention is to provide a transport apparatus which can shorten a time to be required for changing the direction of a carrier.

In order to achieve the object, according to a first aspect of the present invention, the transport apparatus for transporting an article to be transported, comprises: a transport track comprising:

a linear portion comprising a main track for guiding the article to be transported in a straight line direction; and

a branch portion comprising a branch track for guiding the article to be transported so as to change a traveling direction thereof and a linear track for guiding the article to be transported in the straight line direction; and

a switching unit which is provided at the branch portion and switches between the branch track and the linear track so that one of the branch track and the linear track guides the article to be transported in accordance with a traveling direction of the article to be transported.

According to the invention, the switching unit provided at the branch portion performs the switching between the branch track and the linear track so as to guide the article to be transported along one of the branch track and the linear track in accordance with the traveling direction of the article to be transported. Thus, when guiding the article to be transported in the straight line direction and also when guiding the article to be transported so as to change the traveling direction thereof, there is a case that the article to be transported can be transported without being temporarily stopped by merely performing the switching between the branch track and the linear track. Further, since it is not necessary to provide a time for restoring to the original point like the turntable, the time necessary for changing the direction of the article to be transported can be shortened.

According to a second aspect of the present invention as set forth in the first aspect of the present invention, it may be adapted that the switching unit switches between the branch track and the linear track so that one of the branch track and the linear track continues to the main track and the other of the branch track and the linear track is moved away from the article to be transported.

According to the invention, since the switching unit serves to continue one of the branch track and the linear track to the main track and also move the other track away from the article to be transported thereby to switch between the branch track and the linear track. Thus, a time required for the switching can be shortened.

According to a third aspect of the present invention as set forth in the first aspect of the present invention, it may be adapted that the branch track is configured by a plurality of right side rollers and a plurality of left side rollers, each of which is disposed with a predetermined interval along the track and can receive the article to be transported, each of the right side rollers and the left side rollers has a portion for receiving the article to be transported, which is formed by a part of a side surface of a cone having a center axis inclined with respect to a transportation plane of the article to be transported, and the diameter of the right side roller is different from that of the left side roller.

According to the invention, the right side roller has the diameter different from that of the left side roller. Accordingly, the rotation speed of the roller having the large diameter becomes faster than the rotation speed of the roller having the small diameter when the both rollers are rotated. Thus, the article to be transported can be transported smoothly while changing the traveling direction thereof, by using the roller having the large diameter as the roller on the outer periphery side, without using a particular mechanism for making the transporting speed of the article to be transported on the outer periphery side faster than the transporting speed of the article to be transported on the inner periphery side. Further, since each of the left side roller and the right side roller has the article to be transported receiving portion of a tapered shape formed by the part of the side surface of the cone, it is possible to suppress to the minimum the generation of dust due to the slip between the article to be transported and the rollers.

According to a fourth aspect of the present invention, a transport apparatus for transporting an article to be transported, comprises:

a transport track comprising:

a linear portion comprising a main track for guiding the article to be transported in a straight line direction; and

a join portion comprising a join track for guiding the article to be transported so as to join to the main track from the traveling direction different from the main track and a linear track for guiding the article to be transported so as to join to the main track from the traveling direction same as the main track; and

a switching unit which is provided at the join portion and switches between the join track and the linear track so that one of the join track and the linear track guides the article to be transported in accordance with an entering state of the article to be transported into the join portion.

According to the invention, the switching unit provided at the branch portion performs the switching between the branch track and the linear track so as to guide the article to be transported along one of the branch track and the linear track in accordance with the entering state of the article to be transported into the join portion. Thus, when guiding the article to be transported so as to join to the main track from the traveling direction thereof same as the main track and also when guiding the article to be transported so as to join to the main track from the traveling direction of the article different from the main track, there is a case that the article to be transported can be transported without being temporarily stopped by merely performing the switching between the join track and the linear track. Further, since it is not necessary to provide a time for restoring to the origin like the turntable, the time necessary for changing the direction of the article to be transported can be shortened.

According to a fifth aspect of the present invention as set forth in the fourth aspect of the present invention, it may be adapted that the switching unit switches between the join track and the linear track so that one of the join track and the linear track continues to the main track and the other of the join track and the linear track is moved away from the article to be transported.

According to the invention, since the switching unit serves to continue one of the join track and the linear track to the main track and also move the other track away from the article to be transported thereby to switch between the join track and the linear track. Thus, a time required for the switching can be made short.

According to a sixth aspect of the present invention as set forth in the fourth aspect of the present invention, it is may be adapted that the join track is configured by a plurality of right side rollers and a plurality of left side rollers, each of which is disposed with a predetermined interval along the track and can receive the article to be transported, each of the right side rollers and the left side rollers has a portion for receiving the article to be transported, which is formed by a part of a side surface of a cone having a center axis inclined with respect to a transportation plane of the article to be transported, and

the diameter of the right side roller is different from that of the left side roller.

According to the invention, since the right side roller has the diameter different from that of the left side roller, the rotation speed of the roller having the large diameter becomes faster than the rotation speed of the roller having the small diameter when the both rollers are rotated. Thus, the article to be transported can be transported smoothly while changing the traveling direction thereof, by using the roller having the large diameter as the roller on the outer periphery side, without using a particular mechanism for making the transporting speed of the article to be transported on the outer periphery side faster than the transporting speed of the article to be transported on the inner periphery side. Further, since each of the left side roller and the right side roller has the article to be transported receiving portion of a tapered shape formed by the part of the side surface of the cone, it is possible to suppress to the minimum the generation of dust due to the slip between the article to be transported and the rollers.

According to a seventh aspect of the present invention as set forth in the first and fourth aspects of the present invention, it may be adapted that each of at least the rollers on an outer periphery side among the right side rollers and the left side rollers has a flange on the outer periphery side.

According to the invention, the rollers on the outer periphery sides have the flanges on the outer periphery sides thereof respectively. Thus, the flanges can suppress the centrifugal force, which is generated at the article to be transported when the article to be transported travels while changing the traveling direction thereof.

According to an eighth aspect of the present invention as set forth in the first aspect of the present invention, it may be adapted that the switching unit switches between the branch track and the linear track in such a manner that a extensible pole, which is provided at the branch portion, moves a first frame provided at the branch track and a second frame provided at the linear track up and down.

According to a ninth aspect of the present invention as set forth in the fourth aspect of the present invention, it may be adapted that the switching unit switches between the join track and the linear track in such a manner that a extensible pole, which is provided at the join portion, moves a third frame provided at the join track and a fourth frame provided at the linear track up and down.

According to a tenth aspect of the present invention as set forth in the first aspect of the present invention, it may be adapted that the transport apparatus further comprises a sensor which is provided at the branch portion and obtains a information of the article to be transported.

According to an eleventh aspect of the present invention as set forth in the fourth aspect of the present invention, it may be adapted that the transport apparatus further comprises a sensor which is provided at the join portion and obtains a information of the article to be transported.

According to a twelfth aspect of the present invention as set forth in the first aspect of the present invention, it may be adapted that a part of the branch track is provided in order to overlap with a part of the linear portion.

According to a thirteenth aspect of the present invention as set forth in the fourth aspect of the present invention, it may be adapted that a part of the join track is provided in order to overlap with a part of the linear portion.

### BRIEF DESCRIPTION OF THE DRAWINGS

FIG. 1 is a diagram showing the entirety of a transport track constituting a transport apparatus;

FIG. 2 is a diagram illustrating a linear portion and a corner portion;

FIG. 3 is a diagram illustrating a branch portion;

FIG. 4 is a diagram illustrating the branch portion;

FIG. 5 is an enlarged diagram of a main portion A surrounded by a two-dotted chain line in FIG. 4;

FIG. 6 is a cross-sectional diagram cut along a line VI-VI in FIG. 5;

FIG. 7A is an explanatory diagram showing a state where frames are moved up and down by extensible poles and a case where the traveling direction of a carrier is changed;

FIG. 7B is an explanatory diagram showing a state where frames are moved up and down by extensible poles and a case where the traveling direction of a carrier is maintained;

FIG. 8 is a diagram illustrating a join portion;

FIG. 9 is a diagram illustrating the join portion;

FIG. 10 is a flow chart of a branch portion track switching processing routine; and

FIG. 11 is a flow chart of a join portion track switching processing routine.

### DETAILED DESCRIPTION OF EXEMPLARY EMBODIMENTS

Exemplary embodiments of the present invention will hereinafter be described in detail by reference to the accompanying drawings.

(Configuration of the Transport Apparatus 1)

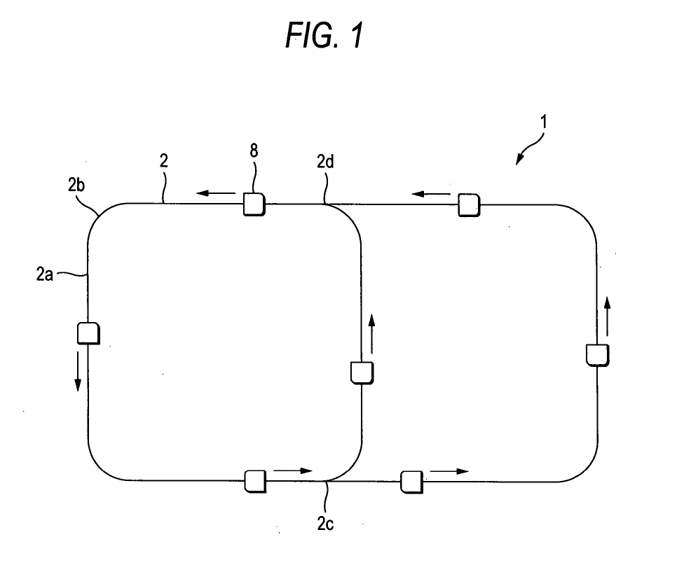

As shown in FIG. 1, the transport apparatus 1 includes a transport track 2 for guiding a carrier 8, which is an article to be transported. The transport track 2 is configured by suitably combining linear portions 2a, corner portions 2b, branch portions 2c and join portions 2d. Not-shown stockers etc. for temporarily keeping the carriers are disposed at the periphery of the transport track 2.

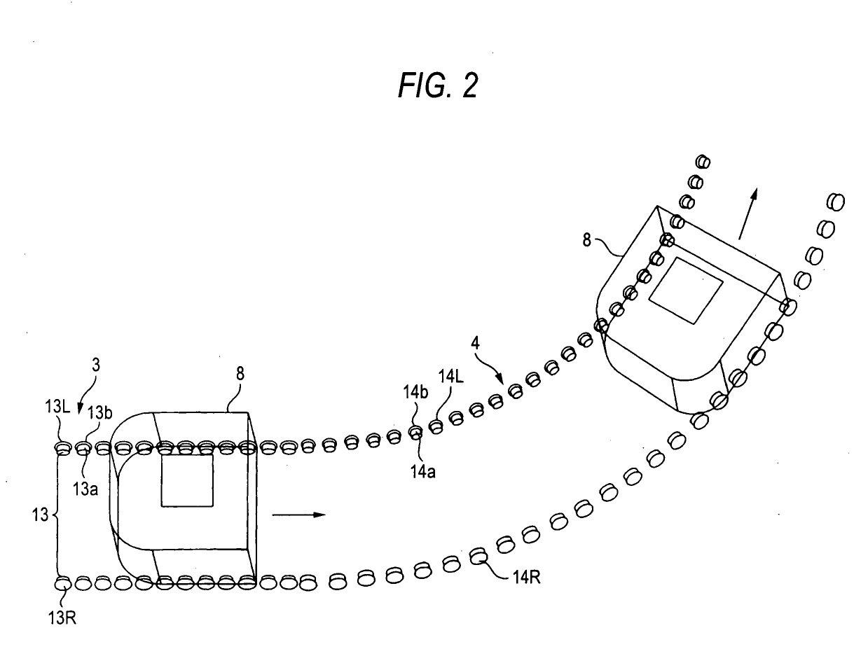

First, the explanation will be made as to the linear portion 2a and the corner portion 2b of the transport track 2 with reference to FIG. 2. As shown in FIG. 2, the linear portion 2a of the transport track 2 is provided with a main track 3 for guiding the carrier 8 in the straight line direction, and the corner portion 2b of the transport track 2 is provided with a corner track 4 for changing the traveling direction of the carrier 8 by 90 degrees. In the corner track 4, the angle for changing the traveling direction of the carrier 8 is not limited to 90 degrees. The main track 3 includes a plurality of main track roller pairs 13 which are disposed with a predetermined interval along a not-shown frame and each of which can receive the carrier 8. The corner track 4 includes a plurality of right side rollers 14R and a plurality of left side rollers 14L which are disposed with a predetermined interval along the not-shown frame and each of which can receive the carrier 8.

Each of rollers 13L and 13R constituting the main track roller pair 13 includes a carrier receiving portion 13a of a cylindrical shape and a flange 13b for forcedly restricting the movement of the carrier in the left and right directions so that the carrier 8 does not run off the main track 3. Each of rollers 14L and 14R provided at the corner track 4 includes a carrier receiving portion 14a of a tapered shape and a flange 14b for forcedly restricting the movement of the carrier in the left and right directions so that the carrier 8 does not run off the corner track 4. In particular, although a centrifugal force directed to the outer peripheral direction acts on the carrier 8 on the corner track 4, this centrifugal force can be suppressed by the flange 14b of the right side roller 14R. The rollers 14L and 14R provided at the corner track 4 have the similar configuration as those of a right side roller and a left side roller provided at each of a branch track 6 and a join track 7 described later, respectively. One of the rollers 13L and 13R constituting the main track roller pair 13 is a driving roller and the other may be a driven roller, or each of them may be a driving roller. Further, one of the rollers 14L and 14R provided at the corner track 4 is a driving roller and the other may be a driven roller, or each of them may be a driving roller. Furthermore, the number of the right side rollers 14R may not be necessarily same as the number of the left side rollers 14L. Usually, the number of the right side rollers 14R on the outer periphery side having a longer track length is slightly larger than the number of the left side rollers 14L on the inner periphery side.

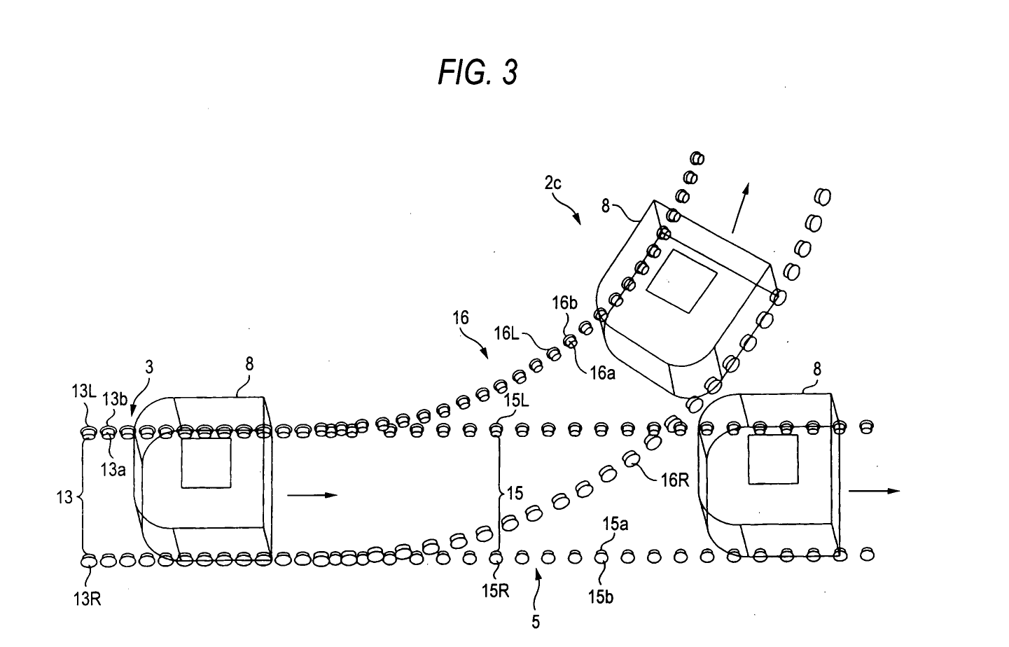

Next, the explanation will be made as to the branch portion 2c of the transport track 2 with reference to FIGS. 3 to 7B. As shown in FIG. 3, the branch portion 2c of the transport track 2 is provided with a linear track 5 for keeping the traveling direction of the carrier 8 in the straight line direction and the branch track 6 for changing the traveling direction of the carrier 8 by 90 degrees in a manner that these linear track and the branch track are partially overlapped. In the branch track 6, the angle for changing the traveling direction of the carrier 8 is not limited to 90 degrees. The linear track 5 includes a plurality of linear track roller pairs 15 which are disposed with a predetermined interval along a not-shown frame and each of which can receive the carrier. The branch track 6 includes a plurality of right side rollers 16R and a plurality of left side rollers 16L which are disposed with a predetermined interval along the not-shown frame and each of which can receive the carrier 8.

Each of rollers 15L and 15R constituting the linear track roller pair 15 includes a carrier receiving portion 15a of a cylindrical shape and a flange 15b for forcedly restricting the movement of the carrier in the left and right directions so that the carrier 8 does not run off the linear track 5. Rollers 16L and 16R provided at the branch track 6 are configured in a similar manner as the rollers 14L and 14R provided at the corner track 4, and each of these right side roller and the left side roller includes a carrier receiving portion 16a of a tapered shape and a flange 16b for forcedly restricting the movement of the carrier in the left and right directions so that the carrier 8 does not run off the branch track 6. In particular, although a centrifugal force directed to the outer peripheral direction acts on the carrier 8 on the branch track 6, this centrifugal force can be suppressed by the flange 16b of the right side roller 16R. One of the rollers 15L and 15R constituting the linear track roller pair 15 is a driving roller and the other may be a driven roller, or each of them may be a driving roller. Further, one of the rollers 16L and 16R provided at the branch track 6 is a driving roller and the other may be a driven roller, or each of them may be a driving roller. Furthermore, the number of the right side rollers 16R may not be necessarily same as the number of the left side rollers 16L. Usually, the number of the right side rollers 16R on the outer periphery side having a longer track length is slightly larger than the number of the left side rollers 16L on the inner periphery side.

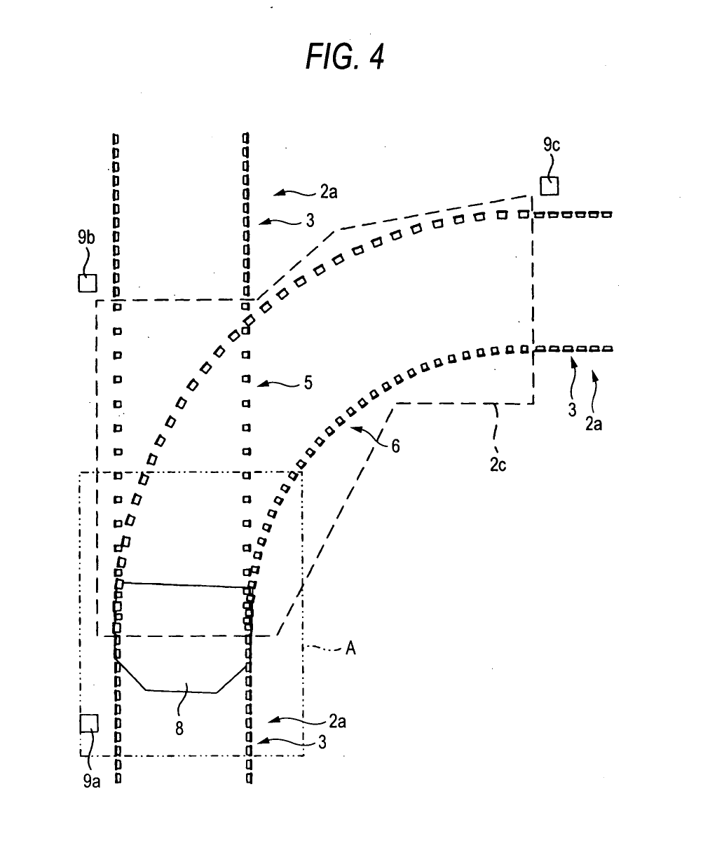

FIG. 4 is a diagram of the branch portion 2c viewed from the bottom side of the carrier 8. In the figure, the branch portion 2c corresponds to an area surrounded by a dotted line. Each of the upstream side (the lower side in the figure) and the downstream side (the upper side in the figure) of the linear track 5 in the branch portion 2c constitutes the linear portion 2a at which the main track 3 is provided. The downstream side (the right side in the figure) of the branch track 6 in the branch portion 2c also constitutes the linear portion 2a at which the main track 3 is provided. A first sensor 9a is provided at the side of the main track 3 on the upstream side of the linear track 5 so as to obtain the information of the carrier 8 entering into the branch portion 2c. In this embodiment, the information of the carriers 8 is identification numbers of the carriers, respectively. Further, a second sensor 9b is provided at a position which is adjacent to the branch portion 2c and on the side of the main track 3 on the downstream side of the linear track 5 so as to detect the carrier 8 passed on the linear track 5 of the branch portion 2c. Furthermore, a third sensor 9c is provided at a position which is adjacent to the branch portion 2c and on the side of the main track 3 on the downstream side of the branch track 6 so as to detect the carrier 8 passed on the branch track 6 of the branch portion 2c.

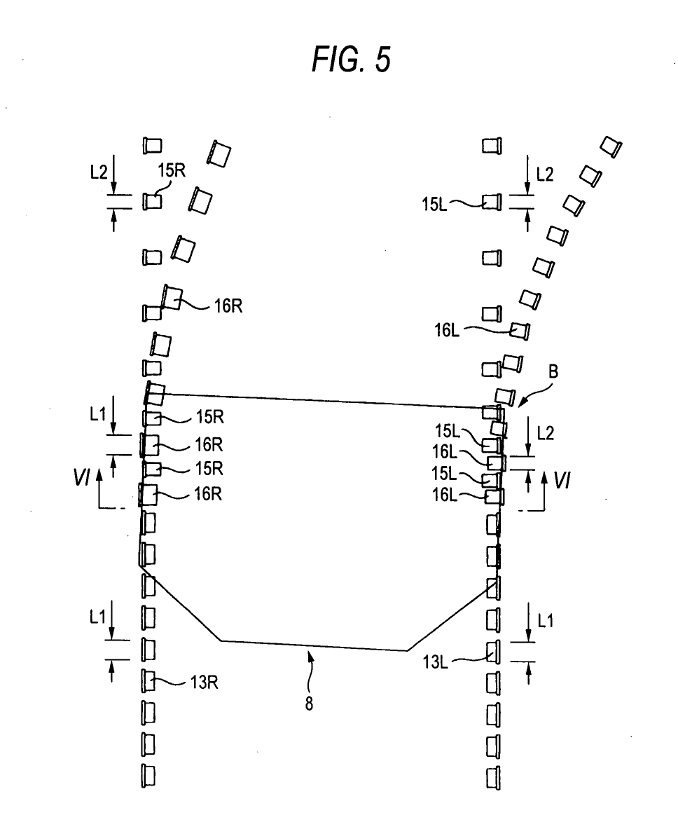

As shown in an enlarged diagram of a main portion A surrounded by a two-dotted chain line in FIG. 5, the rollers 15L, 15R constituting the linear track 5 and the rollers 16R, 16L constituting the branch track 6 are alternately provided continuously at a position B where the branch of the track starts. The diameter of each of the rollers 15L, 15R constituting the linear track roller pair 15 is set to L2. The diameter of the left side roller 16L on the inner periphery side of a curve constituting the linear track roller pair 15 is set to L2, while the diameter of the right side roller 16R on the outer periphery side of the curve is set to L1. The diameter of each of the rollers 13L, 13R constituting the main track roller pair 13 is set to L1. For example, when the curvature radius of the branch track 6 of the branch portion 2c is 1 m, L1 is 30 mm and L2 is 20 mm. The curvature radius and the values of L1, L2 are not limited to these values. In the rollers such as the rollers 16L, 16R each having the carrier receiving portion of a tapered shape, the width of the roller at a position d/2 thereof is defined as the diameter of the roller, where d represents the thickness of the carrier receiving portion. The width of the flange is not contained in the diameter of the roller.

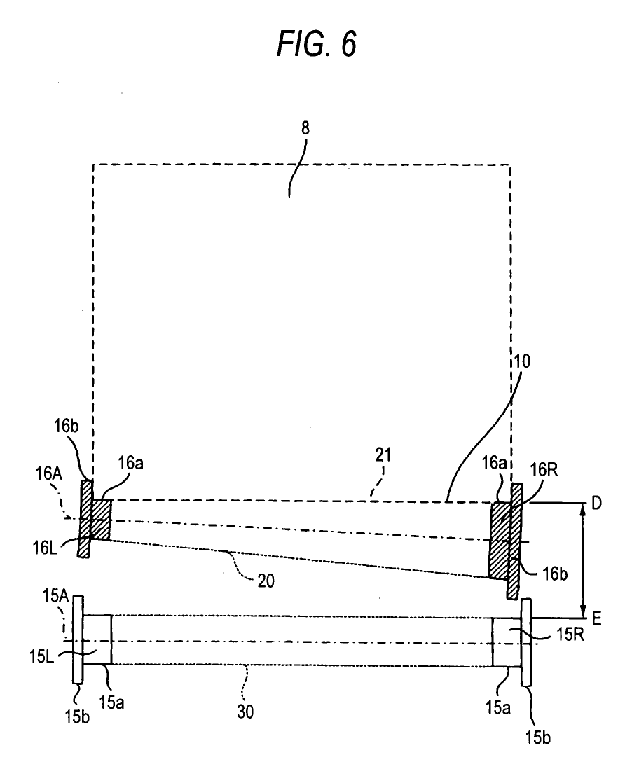

As shown in FIG. 6 which is a cross-sectional diagram cut along a line VI-VI in FIG. 5, the carrier receiving portion 16a of each of the rollers 16L, 16R constituting the branch track 6 forms a part of the side surface of a cone 20 having a center axis 16A inclined with respect to the horizontal plane 10. That is, the carrier receiving portion 16a has a tapered shape. A side surface 21 positioned at the upper end in the vertical direction of the cone 20 having the center axis 16A is set to extend in the horizontal direction. Thus, the carrier 8, which is placed on the carrier receiving portions 16a of the rollers 16L, 16R, is kept to be laid in the horizontal direction. When the diameters of the rollers 16L, 16R constituting the branch track 6 are set to L1, L2 like FIG. 5, respectively, since the diameter of the left side roller 16L differs from the diameter of the right side roller 16R (the right side roller 16R is larger) as described above, the rotation speed of the right side roller 16R having the large diameter becomes faster than the rotation speed of the left side roller 16L having the small diameter when the right side roller 16R and the left side roller 16L are rotated. Thus, the carrier 8 can be transported smoothly while changing the traveling direction thereof, by using the right side roller 16R having the large diameter as the roller on the outer periphery side, without using a particular mechanism for making the transporting speed of the carrier 8 on the outer periphery side having a long traveling length be faster than the transporting speed of the carrier 8 on the inner periphery side having a short traveling length. Further, the slip hardly occurs between the carrier receiving portion 16a and the carrier 8 since the carrier receiving portion 16a is formed in the tapered shape, so that it is possible to suppress the generation of dust due to the slip between the carrier 8 and the rollers 16L, 16R.

On the other hand, the carrier receiving portions 15a of the linear track roller pair 15 constituting the linear track 5 form a part of the side surface of a cylinder 30 having a center axis 15A which is in parallel to (that is, horizontal) to the horizontal plane 10. That is, the carrier receiving portion 15a has a cylindrical shape.

Each of the rollers 14R, 14L constituting the corner track 4 has the potion 14a of a tapered shape like the rollers 16L, 16R constituting the branch track 6 and the flange 14b. Thus, the carrier 8 can be transported smoothly while changing the traveling direction thereof and the generation of dust can be suppressed.

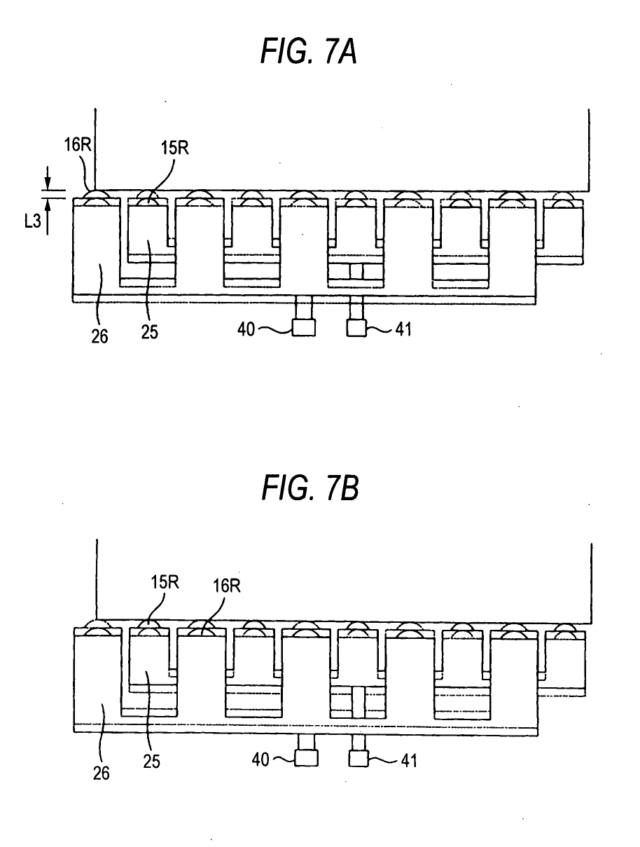

Further, in FIG. 6, a not-shown system controller obtains the information of the carrier 8 entering into the branch portion 2c from the first sensor 9a (see FIG. 4) and changes the traveling direction of the carrier 8 by 90 degrees. In this case, an extensible pole 40 (see FIGS. 7A and 7B), which serves as a switching unit for the transport apparatus 1, is extended thereby to set the height in the vertical direction of the rollers 16L, 16R constituting the branch track 6 to the reference height D (hereinafter called a reference height D) in the vertical direction of the main not-shown track roller pair 13 constituting the main track 3. Further, an extensible pole 41 (see FIGS. 7A and 7B), which serves as a switching unit, is shrunk thereby to set the height in the vertical direction of the rollers 15L, 15R constituting the linear track 5 to a lower position E (hereafter called a lower position E) lower than the reference height D. Although each of the extensible pole 40 and the extensible pole 41 is extended and shrunk by an electrically driving system, it may be driven by an air driving system or a gear driving system.

On the other hand, the not-shown system controller obtains the information of the carrier 8 entering into the branch portion 2c from the first sensor 9a (see FIG. 4) and keeps the traveling direction of the carrier 8 in the straight line direction. In this case, the extensible pole 40 (see FIGS. 7A and 7B) is shrunk thereby to set the height in the vertical direction of the rollers 16L, 16R constituting the branch track 6 to the lower position E. Further, the extensible pole 41 (see FIGS. 7A and 7B) is extended thereby to set the vertical direction of the rollers 15L, 15R constituting the linear track 5 to the reference height D.

To be concrete, as shown in FIGS. 7A and 7B, a frame 26 provided with, for example, five right side rollers 16R of the branch track 6 and a frame 25 provided with, for example, five right side rollers 15R of the linear track 5 are provided in a manner that the right side roller 16R and the right side roller 15R are alternately positioned in the traveling direction of the carrier 8. In accordance with the traveling direction of the carrier 8, the frame 26 is moved up and down by the extensible pole 40 and the frame 25 is moved up and down by the extensible pole 41.

That is, in the case where the traveling direction of the carrier 8 entering into the branch portion 2c is changed by 90 degrees, as shown in FIG. 7A, the frame 26 is located at an upper position by the expansion of the extensible pole 40 so that the upper end of the right side roller 16R of the branch track 6 locates at the reference height D. Further, the frame 25 is located at a lower position by the shrinkage of the extensible pole 41 so that the upper end of the right side roller 15R of the linear track 5 locates at the lower position E where the upper end does not abut against the carrier 8.

In contrast, in the case where the traveling direction of the carrier 8 entering into the branch portion 2c is kept in the straight line direction, as shown in FIG. 7B, the frame 26 is located at the lower position by the shrinkage of the extensible pole 40 so that the upper end of the right side roller 16R of the branch track 6 does not abut against the carrier 8. Further, the frame 25 is located at the higher position by the expansion of the extensible pole 41 so that the upper end of the right side roller 15R of the linear track 5 locates at the reference height D.

A length L3 along which the frame 26 and the frame 25 move up and down is set in view of the heights of the flange 16b and the flange 15b. For example, when the height of each of the flange 16b and the flange 15b is 5 mm, the length L3 along which the frame 26 and the frame 25 move up and down is set to be larger than 5 mm.

Also as to the left side rollers 16L of the branch track 6 and the left side rollers 15L of the linear track 5, frames are moved up and down by extensible poles each serving as a switching unit respectively provided at frames like the frame 25 and 26. Incidentally, the switching unit is not limited to the extensible pole, and any members capable of moving the frame up and down can be employed as the switching unit.

In this manner, the extensible poles 40, 41 provided at the branch portion 2c perform the switching between the branch track 6 and the linear track 5 so as to guide the carrier 8 along one of the branch track 6 and the linear track 5 in accordance with the traveling direction of the carrier 8. Thus, not only when guiding the carrier 8 in the straight line direction but also when guiding the carrier 8 so as to change the traveling direction thereof, there is a case that the carrier 8 can be transported without being temporarily stopped by merely performing the switching between the branch track 6 and the linear track 5. Further, since it is not necessary to provide a time for restoring to the original point like the turntable, the time necessary for changing the direction of the carrier 8 can be shortened.

Further, the extensible poles 40, 41 serve to position one of the branch track 6 and the linear track 5 to the reference height D thereby to continue to the main track 3 and also position the other track to the lower position E thereby to move the other track away from the carrier 8 to switch between the branch track 6 and the linear track 5. Thus, a time required for the switching can be made short.

In FIG. 4, in the case where another carrier 8 is traveling along the branch portion 2c which is the area surrounded by the dotted line, that is, in a state where the second sensor 9b or the third sensor 9c does not detect the another carrier 8 yet after the first sensor 9a obtains the information of the another carrier 8, one carrier 8 intended to travel along the branch portion 2c in the direction different from the traveling direction of the another carrier 8 is temporarily stopped just before the branch portion 2c until the another carrier 8 passes through the branch portion 2c, that is, until the frames 26, 25 are respectively moved up and down by the extensible poles 40, 41 after the second sensor 9b or the third sensor 9c detects the another carrier 8. To be concrete, when the another carrier 8 is traveling along the branch track 6, since the linear track roller pair 15 (rollers 15R, 15L) constituting the linear track 5 are located at the lower position E, the one carrier 8 intended to travel along the linear track 5 is temporarily stopped just before the branch portion 2c until the third sensor 9c detects the another carrier 8 and the frames 25, 26 are located at the reference height D and the lower position E, respectively. Then, the one carrier 8 having been temporarily stopped starts to travel along the linear track 5 after the third sensor 9c detects that the another carrier 8 has passed through the branch track 6, and the rollers 15L, 15R (that is, the linear track 5) and the rollers 16L, 16R (that is, the branch track 6) are set to the reference height D and the lower position E, respectively.

On the other hand, even if another carrier 8 is traveling along the branch portion 2c which is the area surrounded by the dotted line, one carrier 8 intended to travel in the same direction as the traveling direction of the another carrier 8 in the branch portion 2c continues to travel without being temporarily stopped just before the branch portion 2c. This is because it is not necessary to change the heights of the linear track 5 and the branch track 6.

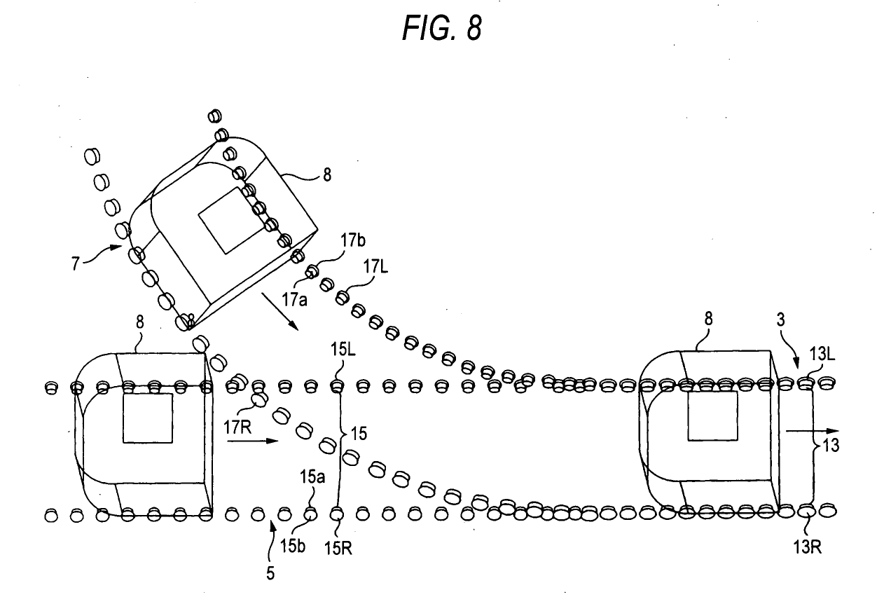

Next, the explanation will be made as to the join portion 2d of the transport track 2 with reference to FIG. 8. As shown in FIG. 8, the join portion 2d is provided with the linear track 5 for keeping the traveling direction of the carrier 8 having been guided by the main track 3 in the straight line direction and the join track 7 for changing the traveling direction of the carrier 8 by 90 degrees thereby to guide the carrier 8 so as to join the main track 3 in a manner that these linear track and the join track are partially overlapped. In the join track 7, the angle for changing the traveling direction of the carrier 8 is not limited to 90 degrees. The linear track 5 has the similar configuration as the linear track 5 of the branch portion 2c and so the explanation thereof will be omitted. The join track 7 includes a plurality of right side rollers 17R and a plurality of left side rollers 17L which are disposed with a predetermined interval along the not-shown frame and each of which can receive the carrier 8.

The rollers 17L and 17R constituting the join track 7 are configured in a similar manner as the rollers 16L and 16R constituting the branch track 6. That is, the roller constituting the join track a carrier receiving portion 17a of a tapered shape and a flange 17b for forcedly restricting the movement of the carrier in the left and right directions so that the carrier 8 does not run off the join track 7. In particular, although a centrifugal force directed to the outer peripheral direction acts on the carrier 8 on the join track 7, this centrifugal force can be suppressed by the flange 17b of the right side roller 17R. Further, the slip hardly occurs between the carrier receiving portion 17a and the carrier 8 since the carrier receiving portion 17a is formed in the tapered shape, so that it is possible to suppress the generation of dust due to the slip between the carrier 8 and the rollers 17L, 17R. Like the rollers 16L and 16R constituting the branch track 6, these rollers 17L, 17R are provided at a frame which is moved up and down by extensible poles like those shown in FIGS. 7A and 7B. One of the rollers 17L and 17R constituting the join track 7 is a driving roller and the other may be a driven roller, or each of them may be a driving roller. Further, the number of the right side rollers 17R may not be necessarily same as the number of the left side rollers 17L. Usually, the number of the right side rollers 17R on the outer periphery side having a longer track length is slightly larger than the number of the left side rollers 17L on the inner periphery side.

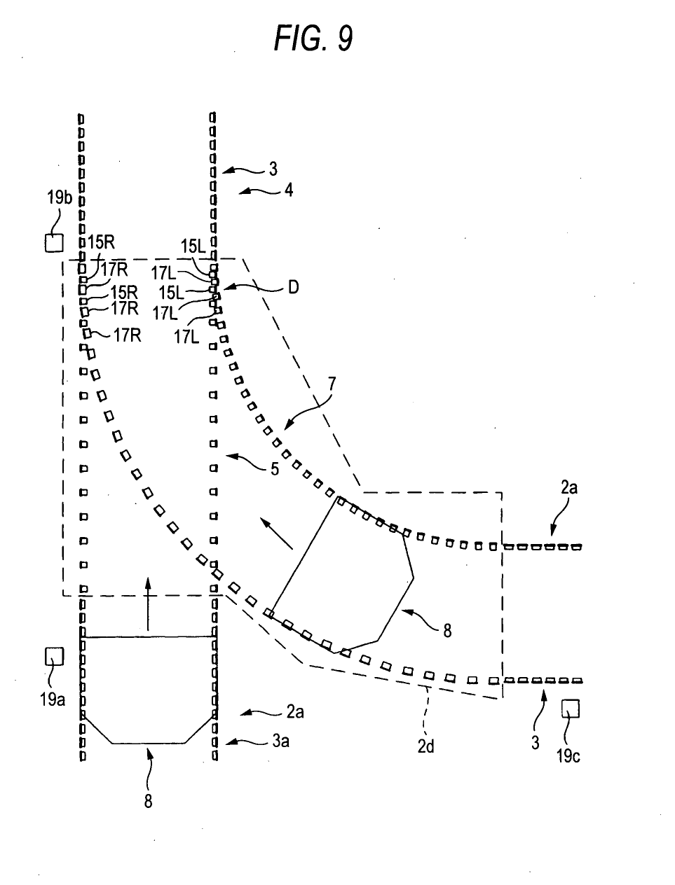

FIG. 9 is a diagram of the join portion 2d seen from the bottom side of the carrier 8. In the figure, the join portion 2d corresponds to an area surrounded by a dotted line. Each of the upstream side (the lower side in the figure) and the downstream side (the upper side in the figure) of the linear track 5 in the join portion 2d constitutes the linear portion 2a at which the main track 3 is provided. The upstream side (the right side in the figure) of the join track 7 in the join portion 2d also constitutes the linear portion 2a at which the main track 3 is provided. A fourth sensor 19a is provided at the side of the main track 3 on the upstream side of the linear track 5 so as to obtain the information of the carrier 8 entering into the join portion 2d. Further, a fifth sensor 19b is provided at a position which is adjacent to the join portion 2d and on the side of the main track 3 on the downstream side of the linear track 5 so as to detect the carrier 8 passed on the linear track 5 of the join portion 2d. Furthermore, a sixth sensor 19c is provided at a position which is adjacent to the join portion 2d and on the side of the main track 3 on the upstream side of the join track 7 so as to detect the carrier 8 entering into the join portion 2d

As shown in FIG. 9, the rollers 15L, 15R constituting the linear track 5 and the rollers 17R, 17L constituting the join track 7 are alternately provided continuously at a position D where the joining of the tracks complete. The diameter of each of the rollers 15L, 15R constituting the linear track 5 is set to L2. The diameter of the left side roller 17L on the inner periphery side of a curve constituting the linear track 5 is set to L2, whilst the diameter of the right side roller 17R on the outer periphery side of the curve is set to L1. For example, when the radius of the curvature of the join track 7 of the branch portion 2c is 1 m, L1 is 30 mm and L2 is 20 mm. The radius of the curvature and the values of L1, L2 are not limited to these values.

Further, in FIG. 9, in the case where the not-shown system controller obtains the information of the carrier 8 entering into the join portion 2d from the sixth sensor 19c, in order to join the carrier 8 located at the upstream side of the join track 7 to the main track 3 on the downstream side of the join portion 2d, a not-shown extensible pole like that shown in FIGS. 7A and 7B is extended to position the frame provided with the rollers 17L, 17R of the join track 7 upward thereby to set the height in the vertical direction of the rollers 17L, 17R (that is, the join track 7) to the reference height D. Further, not-shown another extensible pole is shrunk to position the frame provided with the rollers 15L, 15R of the linear track 5 downward thereby to set the height in the vertical direction of the rollers 15L, 15R (that is, the linear track 5) to the lower position E

On the other hand, in the case where the not-shown system controller obtains the information of the carrier 8 entering into the join portion 2d from the fourth sensor 19a, in order to join the carrier 8 located at the upstream side of the linear track 5 to the main track 3 on the downstream side of the join portion 2d, a not-shown extensible pole is shrunk to position the frame provided with the rollers 17L, 17R of the join track 7 downward thereby to set the height in the vertical direction of the join track 7 to the lower position E. Further, not-shown another extensible pole is extended to position the frame provided with the rollers 15L, 15R of the linear track 5 upward thereby to set the height in the vertical direction of the linear track 5 to the reference height D.

In the case where another carrier 8 is traveling along the branch portion 2c which is the area surrounded by the dotted line, that is, in a state where the system controller does not obtain the detection information of the carrier 8 from the fifth sensor 19b yet after obtaining the information of the another carrier 8 from the fourth sensor 19a or the sixth sensor 19c, one carrier 8 intended to enter into the join portion 2d from the direction different from the traveling direction of the another carrier 8 is temporarily stopped just before the join portion 2d until the another carrier 8 passes through the join portion 2d, that is, until the track is switched from the join track 7 to the linear track 5 after the fifth sensor 19b detects the another carrier 8. To be concrete, when the another carrier 8 is traveling along the join track 7, since the rollers 15R, 15L (that is, the linear track roller pair 15) constituting the linear track 5 are located at the lower position E, the one carrier 8 intended to travel along the linear track 5 is temporarily stopped just before the join portion 2d until the fifth sensor 19b detects the another carrier 8 and the linear track 5 is located at the reference height D and the join track 7 is located at the lower position E. Then, the one carrier 8 having been temporarily stopped starts to travel along the linear track 5 after the fifth sensor 19b detects that the another carrier 8 has passed through the join track 7, and the linear track 5 and the join track 7 are set to the reference height D and the lower position E, respectively. On the other hand, when another carrier 8 is traveling along the linear track 5, since the rollers 17L, 17R constituting the join track 7 are located at the lower position E, one carrier 8 intended to travel along the join track 7 is temporarily stopped just before the join portion 2d until the fifth sensor 19b detects the another carrier 8 and the join track 7 is located at the reference height D and the linear track 5 is located at the lower position E. Then, the one carrier 8 having been temporarily stopped starts to travel along the linear track 5 after the fifth sensor 19b detects that the another carrier 8 has passed through the join track 7, and the linear track 5 and the join track 7 are set to the reference height D and the lower position E, respectively.

On the other hand, even if another carrier 8 is traveling along the join portion 2d which is the area surrounded by the dotted line, one carrier 8 intended to travel in the same direction as the traveling direction of the another carrier 8 in the join portion 2d continues to travel without being temporarily stopped just before the join portion 2d. This is because it is not necessary to change the heights of the linear track 5 and the branch track 6.

Further, in the case where two carriers 8 are intended to enter into the join portion 2d simultaneously from different traveling directions, that is, in the case where the system controller simultaneously obtains the information of the two carriers 8 from the fourth sensor 19a and the sixth sensor 19c, the system controller determines one of the two carriers 8 to be entered into the join portion 2d with a priority. Then, while the one of the carriers 8 thus determined to have a priority is traveling along the join portion 2d, the other carrier 8 is temporarily stopped just before the join portion 2d.

In this manner, the not-shown extensible poles performs the switching between the join track 7 and the linear track 5 so as to guide the carrier 8 along one of the join track 7 and the linear track 5 in accordance with the entering state of the carrier 8 into the join portion 2d. Thus, not only when guiding the carrier 8 so as to join to the main track 3 from the traveling direction same as the main track 3 but also when guiding the carrier 8 so as to join to the main track 3 from the traveling direction different from the main track 3, there is a case that the carrier 8 can be transported without being temporarily stopped by merely performing the switching between the join track 7 and the linear track 5. Further, since it is not necessary to provide a time for restoring to the origin like the turntable, the time necessary for changing the direction of the carrier 8 can be shortened.

Further, the not-shown extensible poles serve to position one of the join track 7 and the linear track 5 to the reference height D thereby to continue to the main track 3 and also position the other track to the lower position E thereby to move the other track away from the carrier 8 to perform the switching between the join track 7 and the linear track 5. Thus, a time required for the switching can be made short.

(Operation of the Transport Apparatus 1)

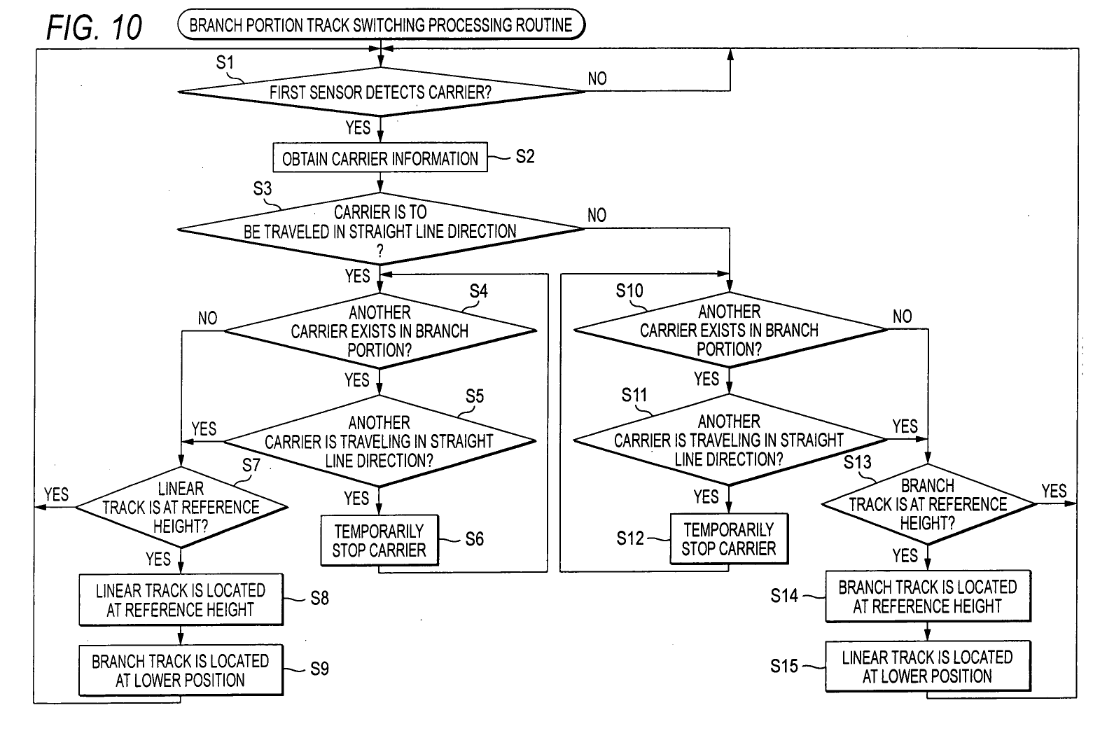

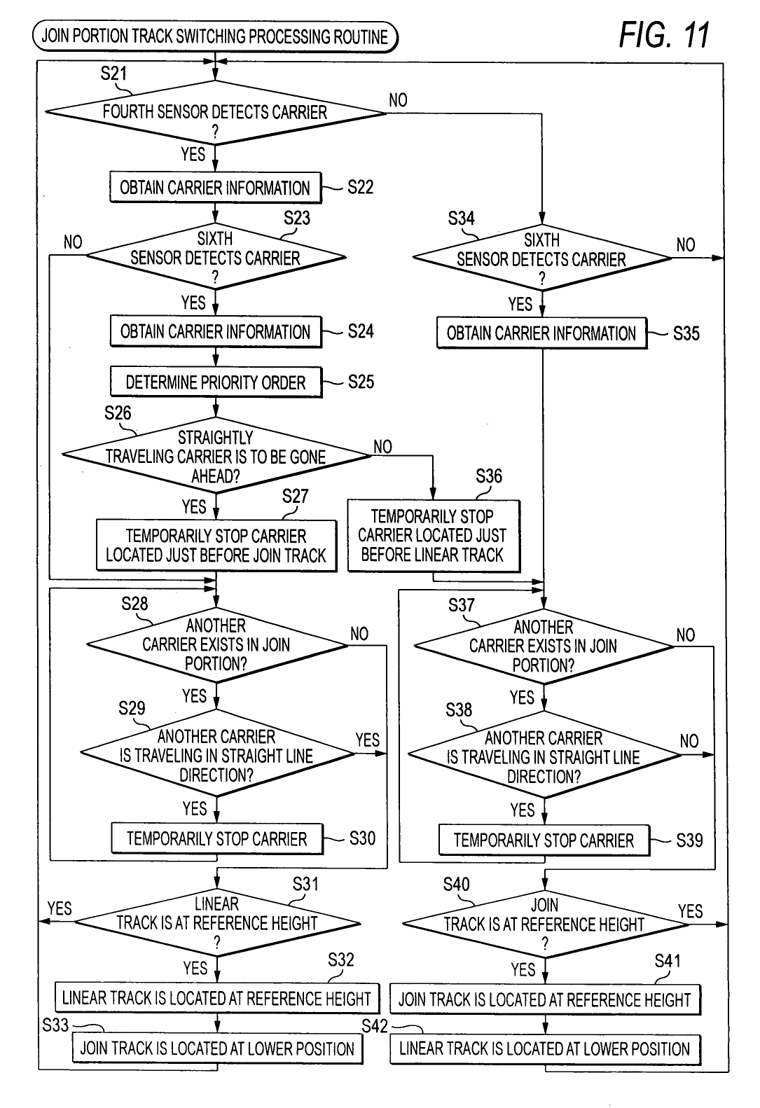

In the aforesaid configuration, the operation of the transport apparatus 1 will be explained with reference to a branch portion track switching processing routine shown in FIG. 10 and a join portion track switching processing routine shown in FIG. 11. The branch portion track switching processing routine shown in FIG. 10 and the join portion track switching processing routine shown in FIG. 11 are executed independently at the branch portion 2c and the join portion 2d, respectively.

First, the explanation will be made as to the branch portion track switching processing routine shown in FIG. 10. When the branch portion track switching processing routine is executed, first, it is determined whether or not the first sensor 9a (see FIG. 4) provided on the side of the main track 3 on the upstream side of the branch portion 2c detects a carrier 8 (step S1). When the first sensor 9a does not detect the carrier 8 (NO in step S1), it is determined that there is no carrier 8 intended to enter into the branch portion 2c and so the process returns to step S1 again. On the other hand, when the first sensor 9a detects one carrier 8 (YES in step S1), the system controller obtains the information of the one carrier 8 (step S2). Then, the system controller determines whether or not the one carrier 8 is to be traveled in the straight line direction (step S3). When it is determined that the one carrier 8 is to be traveled in the straight line direction along the linear track 5 (YES in step S3), it is determined whether or not another carrier 8 exists in the branch portion 2c (step S4).

When the another carrier 8 exists in the branch portion 2c (YES in step S4), it is determined whether or not the another carrier 8 is traveling in the straight line direction (step S5). When the another carrier 8 is not traveling in the straight line direction (NO in step S5), it is determined that the another carrier 8 is traveling along the branch track 6, then the one carrier 8 is temporarily stopped just before the branch portion 2c until the another carrier 8 passes through the branch track 6 (step S6), and then the process returns to step S4 again. On the other hand, when it is determined in step S4 that the another carrier 8 does not exist in the branch portion 2c (NO in step S4) or it is determined in step S5 that the another carrier 8 is traveling in the straight line direction (YES in step S5), it is determined whether or not the linear track 5 is located at the reference height D (step S7). When the linear track 5 is located at the reference height D (YES in step S7), the one carrier 8 travels along the linear track 5 without switching the tracks and then the process returns to step S1 again.

On the other hand, when the linear track 5 is not located at the reference height D (NO in step S7), the linear track 5 is located at the reference height D by the extensible pole 41 (step S8) and the branch track 6 is located at the lower position E by the extensible pole 40 (step S9), whereby the one carrier 8 travels along the linear track 5 and then the process returns to step S1 again.

In this manner, when traveling the carrier 8 in the straight line direction, the extensible poles 40, 41 provided at the branch portion 2c switch the branch track 6 and the linear track 5 so as to guide the carrier 8 along the linear track 5 in accordance with the traveling direction (straight line direction) of the carrier 8. Thus, there is a case that the carrier 8 can be transported without being temporarily stopped by merely performing the switching between the branch track 6 and the linear track 5. Further, since it is not necessary to provide a time for restoring to the origin like the turntable, the time necessary for changing the direction of the carrier 8 can be shortened.

Further, when traveling the carrier 8 in the straight line direction, since the extensible pole 41 locates the linear track 5 at the reference height D thereby to continue to the main track 3 and also the extensible pole 40 locates the branch track 6 to the lower position E thereby to move this track away from the carrier 8 to perform the switching between the branch track 6 and the linear track 5. Thus, a time required for the switching can be made short.

When it is determined that the one carrier 8 is not to be traveled in the straight line direction (NO in step S3), it is determined that the one carrier 8 is to be traveled along the branch track 6 and so it is determined whether or not another carrier 8 exists in the branch portion 2c (step S10).

When the another carrier 8 exists in the branch portion 2c (YES in step S10), it is determined whether or not the another carrier 8 is traveling in the straight line direction (step S11). When the another carrier 8 is traveling in the straight line direction (YES in step S11), it is determined that the another carrier 8 is traveling along the linear track 5, then the one carrier 8 is temporarily stopped just before the branch portion 2c until the another carrier 8 passes through the linear track 5 (step S12), and then the process returns to step S10 again. On the other hand, when it is determined in step S10 that the another carrier 8 does not exist in the branch portion 2c (NO in step S10) or it is determined in step S11 that the another carrier 8 is not traveling in the straight line direction (NO in step S11), it is determined whether or not the branch track 6 is located at the reference height D (step S13). When the branch track 6 is located at the reference height D (YES in step 137), the carrier 8 travels along the branch track 6 without switching the tracks and then the process returns to step S1 again.

On the other hand, when the branch track 6 is not located at the reference height D (NO in step S13), the branch track 6 is located at the reference height D by the extensible pole 40 (step S14) and the linear track 5 is located at the lower position E by the extensible pole 41 (step S15), whereby the one carrier 8 travels along the branch track 6 and then the process returns to step S1 again.

In this manner, when traveling the carrier 8 on a curved track, the extensible poles 40, 41 provided at the branch portion 2c switch the branch track 6 and the linear track 5 so as to guide the carrier 8 along the branch track 6 in accordance with the traveling direction (curved direction) of the carrier 8. Thus, not only when guiding the carrier 8 in the straight line direction but also when guiding the carrier 8 so as to change the traveling direction thereof, there is a case that the carrier 8 can be transported without being temporarily stopped by merely performing the switching between the branch track 6 and the linear track 5. Further, since it is not necessary to provide a time for restoring to the origin like the turntable, the time necessary for changing the direction of the carrier 8 can be shortened.

Further, when traveling the carrier 8 on a curved track, since the extensible pole 40 locates the branch track 6 at the reference height D thereby to continue to the main track 3 and also the extensible pole 41 locates the linear track 5 to the lower position E thereby to move this track away from the carrier 8 to perform the switching between the branch track 6 and the linear track 5. Thus, a time required for the switching can be made short.

Since the diameter of the left side roller 16L constituting the branch track 6 differs from the diameter of the right side roller 16R also constituting the branch track (the right side roller 16R is larger), the rotation speed of the right side roller 16R having the large diameter becomes larger than the rotation speed of the left side roller 16L having the small diameter when the rollers 16R, 16L are rotated. Thus, the carrier 8 can be transported smoothly, while changing the traveling direction thereof and using the right side roller 16R having the large diameter as the roller on the outer periphery side, without using a particular mechanism for making the transporting speed of the carrier 8 on the outer periphery side having a long traveling length be higher than the transporting speed of the carrier 8 on the inner periphery side having a short traveling length. Further, since the carrier receiving portion 16a of each of the left side roller 16L and the right side roller 16R is formed in the tapered shape, it is possible to suppress the generation of dust due to the slip between the carrier 8 and the rollers 16L, 16R.

Further, since the flange 16b is provided at the right side roller 16R, the centrifugal force acting on the carrier 8 on the branch track 6 can be suppressed by the flange 16b.

Next, the explanation will be made as to the join portion track switching processing routine shown in FIG. 11. When the join portion track switching processing routine is executed, first, it is determined whether or not the fourth sensor 19a (see FIG. 9) provided on the side of the main track 3 on the upstream side of the linear track 5 of the join portion 2d detects a carrier 8 (step S21). When the fourth sensor 19a detects the carrier 8 (YES in step S21), the system controller obtains the information of the one carrier 8 (step S22). Then, it is determined whether or not the sixth sensor 19c (see FIG. 9), provided at the position which is adjacent to the join portion 2d and on the side of the main track 3 on the upstream side of the join track 7, detects a carrier 8 (step S23) When the sixth sensor 19c detects the carrier 8 (YES in step S23), the system controller obtains the information of the carrier 8 (step S24).

Then, the system controller determines one of the carrier 8 detected by the fourth sensor 19a and the carrier 8 detected by the sixth sensor 19c to be entered into the join portion 2d with a priority (step S25) and further determined whether or not the carrier 8 straightly traveling on the linear track 5 is to be gone ahead (step S26). When the carrier 8 straightly traveling on the linear track 5 is determined to be gone ahead (YES in step S26), the carrier 8 located just before the join track 7 is temporarily stopped (step S27). Then, it is determined whether or not there exists another carrier 8 in the join portion 2d (step S28).

When the another carrier 8 exists in the join portion 2d (YES in step S28), it is determined whether or not the another carrier 8 is traveling in the straight line direction (step S29). When the another carrier 8 is not traveling in the straight line direction (NO in step S29), it is determined that the another carrier 8 is traveling along the join track 7, then one carrier 8 is temporarily stopped just before the join portion 2d until the another carrier 8 passes through the join track 7 (step S30), and then the process returns to step S28 again. On the other hand, when it is determined in step S28 that the another carrier 8 does not exist in the join portion 2d (NO in step S28) or it is determined in step S29 that the another carrier 8 is traveling in the straight line direction (YES in step S29), it is determined whether or not the linear track 5 is located at the reference height D (step S31). When the linear track 5 is located at the reference height D (YES in step S31), the one carrier 8 travels along the linear track 5 without switching the tracks and then the process returns to step S1 again.

On the other hand, when the linear track 5 is not located at the reference height D (NO in step S31), the linear track 5 is located at the reference height D by the extensible pole (step S32) and the join track 7 is located at the lower position E by the other extensible pole (step S33), whereby the one carrier 8 travels along the linear track 5 and then the process returns to step S1 again.

In this manner, when entering the carrier 8 into the linear track 5 in accordance with the entering state of the carriers 8 in the join portion 2d, the extensible pole provided at the join portion 2d switches the join track 7 and the linear track 5 so as to guide the carrier 8 along the linear track 5. Thus, there is a case that the carrier 8 can be transported without being temporarily stopped by merely performing the switching between the join track 7 and the linear track 5. Further, since it is not necessary to provide a time for restoring to the original point like the turntable, the time necessary for changing the direction of the carrier 8 can be shortened.

Further, when going ahead the carrier 8 traveling in the straight line direction on the linear track 5, since the not-shown extensible pole locates the linear track 5 at the reference height D thereby to continue to the main track 3 and also the not-shown other extensible pole locates the join track 7 to the lower position E thereby to move this track away from the carrier 8 to perform the switching between the join track 7 and the linear track 5. Thus, a time required for the switching can be made short.

On the other hand, in step S26, when the carrier 8 straightly traveling on the linear track 5 is not to be gone ahead (NO in step S26), the carrier 8 located just before the linear track 5 is temporarily stopped (step S36) and the process proceeds to step S37.

Further, in step S21, when the fourth sensor 19a does not detect the carrier 8 (NO in step S21), it is determined whether or not the sixth sensor 19c detects the carrier 8 (step S34). When the sixth sensor 19c does not detect the carrier 8 (NO in step S34), the process returns to step S 21 again. On the other hand, when the sixth sensor 19c detects the carrier 8 (YES in step S34), the system controller obtains the information of the carrier 8 (step S35) and the process proceeds to step S37

After step S35 or S36, it is determined whether or not there exists another carrier 8 in the join portion 2d (step S37). When the another carrier 8 exists in the join portion 2d (YES in step S37), it is determined whether or not the another carrier 8 is traveling in the straight line direction (step S38). When the another carrier 8 is traveling in the straight line direction (YES in step S38), it is determined that the another carrier 8 is traveling along the linear track 5. Then, one carrier 8 is temporarily stopped just before the join portion 2d until the another carrier 8 passes through the linear track 5 (step S39), and then the process returns to step S37 again.

On the other hand, when it is determined in step S37 that the another carrier 8 does not exist in the join portion 2d (NO in step S37) or it is determined in step S38 that the another carrier 8 is not traveling in the straight line direction (NO in step S38), it is determined whether or not the join track 7 is located at the reference height D (step S40). When the join track 7 is located at the reference height D (YES in step S40), the one carrier 8 travels along the join track 7 without switching the tracks and then the process returns to step S1 again. On the other hand, when the join track 7 is not located at the reference height D (NO in step S40), the join track 7 is located at the reference height D by the not-shown extensible pole (step S41) and the linear track 5 is located at the lower position E by the not-shown other extensible pole (step S42), whereby the one carrier 8 travels along the join track 7 and then the process returns to step S1 again.

In this manner, when entering the carrier 8 into the join track 7 in accordance with the entering state of the carriers 8 in the join portion 2d, the not-shown extensible pole provided at the join portion 2d switches the join track 7 and the linear track 5 so as to guide the carrier 8 along the join track 7. Thus, there is a case that the carrier 8 can be transported without being temporarily stopped by merely performing the switching between the join track 7 and the linear track 5. Further, since it is not necessary to provide a time for restoring to the origin like the turntable, the time necessary for changing the direction of the carrier 8 can be shortened.

Further, when going ahead the carrier 8 traveling in the curved direction on the join track 7, since the not-shown extensible pole locates the join track 7 at the reference height D thereby to continue to the main track 3 and also the not-shown other extensible pole locates the linear track 5 to the lower position E thereby to move this track away from the carrier 8 to perform the switching between the join track 7 and the linear track 5. Thus, a time required for the switching can be made short.

Since the diameter of the left side roller 17L constituting the join track 7 differs from the diameter of the right side roller 17R also constituting the join track (the right side roller 17R is larger), the rotation speed of the right side roller 17R having the large diameter becomes faster than the rotation speed of the left side roller 17L having the small diameter when the rollers 17R, 17L are rotated. Thus, the carrier 8 can be transported smoothly while changing the traveling direction thereof, by using the right side roller 17R having the large diameter as the roller on the outer periphery side, without using a particular mechanism for making the transporting speed of the carrier 8 on the outer periphery side having a long traveling length be faster than the transporting speed of the carrier 8 on the inner periphery side having a short traveling length. Further, since the carrier receiving portion 17a of each of the left side roller 17L and the right side roller 17R is formed in the tapered shape, it is possible to suppress the generation of dust due to the slip between the carrier 8 and the rollers 17L, 17R.

Further, since the flange 17b is provided at the right side roller 17R, the centrifugal force acting on the carrier 8 on the join track 7 can be suppressed by the flange 17b.

(Abstract of the Present Embodiment)

As described above, the transport apparatus 1 according to the embodiment is the transport apparatus 1 for transporting a carrier 8, and said transport apparatus 1 includes: the transport track 2 which has:

the linear portion 2a having the main track 3 for guiding the carrier 8 in the straight line direction; and

the branch portion 2c provided with the branch track 6 for guiding the carrier 8 so as to change the traveling direction thereof and the linear track 5 for guiding the carrier 8 in the straight line direction; and

the extensible poles 40, 41 which are provided at the branch portion 2c and switch between the branch track 6 and the linear track 5 so that one of the branch track 6 and the linear track 5 guides the carrier 8 in accordance with the traveling direction of the carrier 8.

According to this configuration, the extensible poles 40, 41 provided at the branch portion 2c perform the switching between the branch track 6 and the linear track 5 so as to guide the carrier 8 along one of the branch track 6 and the linear track 5 in accordance with the traveling direction of the carrier 8. Thus, not only when guiding the carrier 8 in the straight line direction but also when guiding the carrier 8 so as to change the traveling direction thereof, there is a case that the carrier 8 can be transported without being temporarily stopped by merely performing the switching between the branch track 6 and the linear track 5. Further, since it is not necessary to provide a time for restoring to the origin like the turntable, the time necessary for changing the direction of the carrier 8 can be shortened.

Further, in the transport apparatus 1 according to the embodiment, the extensible poles 40, 41 are configured to position one of the branch track 6 and the linear track 5 so as to continue to the main track 3 and also position the other track so as to move away from the carrier 8 thereby to switch between the branch track 6 and the linear track 5. According to this configuration, since the extensible poles 40, 41 serve to continue one of the branch track 6 and the linear track 5 to the main track 3 and also move the other track away from the carrier 8 thereby to switch between the branch track 6 and the linear track 5. Thus, a time required for the switching can be made short.

Further, in the transport apparatus 1 according to the embodiment, the branch track 6 is configured by a plurality of the right side rollers 16R and a plurality of the left side rollers 16L which are disposed with the predetermined interval along the track and each of which can receive the carrier 8. The carrier receiving portion 16a of each of the rollers 16L, 16R forms a part of the side surface of the cone 20 having the center axis 16A inclined with respect to the transportation plane of the carrier 8. Thus, the right side roller 16R has the diameter different from that of the left side roller 16L. According to this configuration, since the right side roller 16R has the diameter different from that of the left side roller 16L, the rotation speed of the right side roller 16R having the large diameter becomes faster than the rotation speed of the left side roller 16L having the small diameter when the rollers 16R, 16L are rotated. Thus, the carrier 8 can be transported smoothly while changing the traveling direction thereof, by using the right side roller 16R having the large diameter as the roller on the outer periphery side, without using a particular mechanism for making the transporting speed of the carrier 8 on the outer periphery side faster than the transporting speed of the carrier 8 on the inner periphery side. Further, since each of the left side roller 16L and the right side roller 16R has the carrier receiving portion 16a of a tapered shape formed by the part of the side surface of the cone 20, it is possible to suppress to the minimum the generation of dust due to the slip between the carrier 8 and the rollers.

Furthermore, in the transport apparatus 1 according to the embodiment is the transport apparatus 1 for transporting a carrier 8, and said transport apparatus includes: the transport track 2 which has:

the linear portion 2a having the main track 3 for guiding the carrier 8 in the straight line direction; and

the join portion 2d provided with the join track 7 for guiding the carrier 8 so as to join to the main track 3 from the traveling direction of the carrier different from the main track 3 and the linear track 5 for guiding the carrier 8 so as to join to the main track 3 from the traveling direction of the carrier same as the main track 3; and

the extensible poles which are provided at the join portion 2d and switch between the join track 7 and the linear track so that one of the join track 7 and the linear track 5 guides the carrier 8 in accordance with the entering state into the join portion 2d of the carrier 8.

According to this configuration, the not-shown extensible poles provided at the join portion 2d perform the switching between the join track 7 and the linear track 5 so as to guide the carrier 8 along one of the join track 7 and the linear track 5 in accordance with the entering state of the carrier into the join portion 2d. Thus, not only when guiding the carrier 8 so as to join to the main track 3 from the traveling direction same as the main track 3 but also when guiding the carrier 8 so as to join to the main track 3 from the traveling direction different from the main track 3, there is a case that the carrier 8 can be transported without being temporarily stopped by merely performing the switching between the join track 7 and the linear track 5. Further, since it is not necessary to provide a time for restoring to the origin like the turntable, the time necessary for changing the direction of the carrier 8 can be shortened.

Further, in the transport apparatus 1 according to the embodiment, the extensible poles are configured to position one of the join track 7 and the linear track 5 so as to continue to the main track 3 and also position the other track so as to move away from the carrier 8 thereby to switch between the join track 7 and the linear track 5. According to this configuration, since the extensible poles serve to continue one of the join track 7 and the linear track 5 to the main track 3 and also move the other track away from the carrier 8 thereby to perform the switching between the join track 7 and the linear track 5. Thus, a time required for the switching can be made short.

Further, in the transport apparatus 1 according to the embodiment, the join track 7 is configured by a plurality of the right side rollers 17R and a plurality of the left side rollers 17L which are disposed with the predetermined interval along the track and each of which can receive the carrier 8. The rollers 17L, 17R are configured in a manner that a part of the side surface of the cone 20 having the center axis inclined with respect to the transportation plane of the carrier 8 forms the carrier receiving portion 17a of each of the right side and left side rollers. Thus, the right side roller 17R has the diameter different from that of the left side roller 17L. According to this configuration, since the right side roller 17R has the diameter different from that of the left side roller 17L, the rotation speed of the right side roller 17R having the large diameter becomes larger than the rotation speed of the left side roller 17L having the small diameter when the rollers 17R, 17L are rotated. Thus, the carrier 8 can be transported smoothly while changing the traveling direction thereof, by using the right side roller 17R having the large diameter as the roller on the outer periphery side, without using a particular mechanism for making the transporting speed of the carrier 8 on the outer periphery side faster than the transporting speed of the carrier 8 on the inner periphery side. Further, since each of the left side roller 17L and the right side roller 17R has the carrier receiving portion 17a of a tapered shape formed by the part of the side surface of the cone 20, it is possible to suppress to the minimum the generation of dust due to the slip between the carrier 8 and the rollers.

Furthermore, the transport apparatus 1 according to the embodiment is configured in a manner that at least the right side rollers 16R, 17R on the outer periphery sides among the right side rollers 16R, 17R and the left side rollers 16L, 17L are provided with flanges 16b, 17b on the outer periphery sides thereof, respectively. According to this configuration, since the right side rollers 16R, 17R on the outer periphery sides have the flanges 16b, 17b on the outer periphery sides thereof, respectively, the centrifugal force generated at the carrier 8 when the carrier 8 travels while changing the traveling direction thereof can be suppressed by the flanges 16b, 17b.

(Modified Example of the Embodiment of the Invention)

Although the explanation is made based on the preferred embodiment of the invention, the various modification may be made in a range without changing the gist of the invention. That is, in FIG. 6, the axis 16A of the cone may be laid in the horizontal direction, for example, so that the side surface 21 located at the upper end in the vertical direction of the cone 20 is slanted in a manner that the right side roller 16R side constituting the branch track 6 is located at a higher position. According to this configuration, there is a case that the centrifugal force generated at the carrier 8 can be suppressed more preferably by the flange 16b of the right side roller 16R. This feature is also applied to the right side roller 17R constituting the join track 7. While the invention has been described in connection with the exemplary embodiments, it will be obvious to those skilled in the art that various changes and modification may be made therein without departing from the present invention, and it is aimed, therefore, to cover in the appended claim all such changes and modifications as fall within the true spirit and scope of the present invention.

What is claimed is:

1. A transport apparatus for transporting an article to be transported, comprising:
a transport track comprising:
a linear portion comprising a main track for guiding the article to be transported in a straight line direction; and
a branch portion comprising:
a branch track for guiding the article to be transported so as to change a traveling direction thereof; and
a linear track for guiding the article to be transported in the straight line direction; and
a switching unit which is provided at the branch portion and switches between the branch track and the linear track so that one of the branch track and the linear track guides the article to be transported in accordance with the traveling direction of the article to be transported.

2. The transport apparatus according to claim 1,
wherein the switching unit switches between the branch track and the linear track in such a manner that one of the branch track and the linear track continues to the main track and the other of the branch track and the linear track is moved away from the article to be transported.

3. The transport apparatus according to claim 1, wherein
the branch track comprises a plurality of right side rollers and a plurality of left side rollers, each of which is disposed with a predetermined interval along the track and receives the article to be transported,
each of the right side rollers and the left side rollers has a portion for receiving the article to be transported, the portion being formed by a part of a side surface of a cone whose center axis is inclined with respect to a transportation plane of the article to be transported, and
a diameter of the right side roller is different from that of the left side roller.

4. The transport apparatus according to claim 2, wherein
the branch track comprises a plurality of right side rollers and a plurality of left side rollers, each of which is disposed with a predetermined interval along the track and can receive the article to be transported,
each of the right side rollers and the left side rollers has a portion for receiving the article to be transported, the portion being formed by a part of a side surface of a cone whose center axis is inclined with respect to a transportation plane of the article to be transported, and
a diameter of the right side roller is different from that of the left side roller.

5. A transport apparatus for transporting an article to be transported, comprising:
a transport track comprising:
a linear portion comprising a main track for guiding the article to be transported in a straight line direction; and
a join portion comprising:
a join track for guiding the article to be transported so as to join to the main track from a traveling direction different from the main track; and
a linear track for guiding the article to be transported so as to join to the main track from the traveling direction same as the main track; and
a switching unit which is provided at the join portion and switches between the join track and the linear track so that one of the join track and the linear track guides the article to be transported in accordance with an entering state of the article to be transported into the join portion.

6. The transport apparatus according to claim 5,
wherein the switching unit switches between the join track and the linear track in such a manner that one of the join track and the linear track continues to the main track and the other of the join track and the linear track is moved away from the article to be transported.

7. The transport apparatus according to claim 5, wherein
the join track comprises a plurality of right side rollers and a plurality of left side rollers, each of which is disposed with a predetermined interval along the track and receives the article to be transported,
each of the right side rollers and the left side rollers has a portion for receiving the article to be transported, the portion being formed by a part of a side surface of a cone whose center axis is inclined with respect to a transportation plane of the article to be transported, and
a diameter of the right side roller is different from that of the left side roller.

8. The transport apparatus according to claim 6, wherein
the join track comprises a plurality of right side rollers and a plurality of left side rollers, each of which is disposed with a predetermined interval along the track and can receive the article to be transported,
each of the right side rollers and the left side rollers has a portion for receiving the article to be transported, the portion being formed by a part of a side surface of a cone whose center axis is inclined with respect to a transportation plane of the article to be transported, and
a diameter of the right side roller is different from that of the left side roller.

9. The transport apparatus according to claim 3,
wherein at least the rollers, which is positioned at an outer periphery side defined as a curved portion of the branch portion, has a flange on an outer periphery of the rollers.

10. The transport apparatus according to claim 7,
wherein at least the rollers, which is positioned at an outer periphery side defined as a curved portion of the join portion, has a flange on an outer periphery of the rollers.

11. The transport apparatus according to claim 1, wherein
the switching unit switches between the branch track and the linear track in such a manner that an extensible pole, which is provided at the branch portion, moves the branch track and the linear track up and down.

12. The transport apparatus according to claim 5, wherein
the switching unit switches between the join track and the linear track in such a manner that an extensible pole, which is provided at the join portion, moves the join track and the linear track up and down.

13. The transport apparatus according to claim 1, further comprising:
a sensor which is provided at the branch portion and obtains information of the article to be transported.

14. The transport apparatus according to claim 5, further comprising:
a sensor which is provided at the join portion and obtains information of the article to be transported.

15. The transport apparatus according to claim 1,
wherein a part of the branch track is provided so as to overlap with a part of the linear portion.

16. The transport apparatus according to claim 5,
wherein a part of the join track is provided so as to overlap with a part of the linear portion.
